(19) United States
(12) Patent Application Publication
(10) Pub. No.: US 2026/0287715 A1
(43) Pub. Date: Sep. 24, 2026

(54) METHODS AND SYSTEMS FOR DETECTION AND CANCELLATION OF ATTACK SIGNALS

(71) Applicant: Qorvo US, Inc., Greensboro, NC (US)

(72) Inventors: Eric PERRAUD, Toulouse (FR); Oisín Aodh Ó CUANACHÁIN, Dublin (IE)

(21) Appl. No.: 19/473,696

(22) PCT Filed: Apr. 30, 2024
(86) PCT No.: PCT/US2024/027045

§ 371 Date: Oct. 8, 2025

Related U.S. Application Data
(60) Provisional application No. 63/500,863, filed on May 8, 2023.
(60) Provisional application No. 63/515,702, filed on Jul. 26, 2023.
(60) Provisional application No. 63/619,072, filed on Jan. 9, 2024.

(51) Int. Cl. G01S 7/36; G01S 13/08; H04W 12/122; H04W 12/63

(52) U.S. Cl. CPC G01S 7/36; G01S 13/08; H04W 12/122; H04W 12/63

(57) ABSTRACT

Systems, methods, and devices as described herein provide a method for detecting and cancelling an attack signal during a ranging round comprising: receiving a first message from a first device at a second device; transmitting a second message from the second device to the first device; receiving a third message from the first device at the second device; transmitting a fourth message from the second device to the first device; computing, at the second device, a first time-of-flight based on a plurality of timestamps associated with the first message, the second message, and the third message; and receiving a fifth message from the first device at the second device, wherein the fifth message includes a second time-of-flight computed by the first device or an invalidation message of the ranging round.

### CROSS-REFERENCE TO RELATED APPLICATIONS

The present application claims the benefit of U.S. Provisional Application No. 63/500,863, filed May 8, 2023, U.S. Provisional Application No. 63/515,702, filed Jul. 26, 2023 and U.S. Provisional Application No. 63/619,072, filed Jan. 9, 2024, which are incorporated herein by reference in their entirety

### FIELD OF THE DISCLOSURE

The present disclosure relates to ultra-wideband-enabled devices, systems, and methods for detection and cancellation of attack signals in ultra-wideband (UWB) signaling.

### BACKGROUND

Ultra-wideband (UWB) is a radio technology that is able to use a very low energy level for short-range, high-bandwidth communications over a large portion of the radio spectrum. More specifically, Ultra-Wideband (UWB) is a wireless communication technology that uses a wide bandwidth, typically about 500 MHz or larger, or has a 10 dB bandwidth greater than 20% of the center frequency, as defined, e.g., in ITU-R SM.1755-0: “Characteristics of ultra-wideband technology”, ITU, 2006. For example, UWB technology can be used in ranging, which is a process of determining the distance between two devices using UWB technology. UWB technology can also be used in short-range data transactions. Today, UWB technology is used in various applications that involve short-range ranging and data transactions, such as, for example, keyless car access.

UWB typically operates within the unlicensed spectrum and devices are required to respect the relevant legal regulations, including a transmission mask. A ranging round is often used to establish a wireless connection between two UWB devices. During a ranging session two UWB devices transmit signals to establish contact between the two devices.

Additionally, IEEE 802.15.4z has introduced the Scrambled Timestamp Sequence (STS) to allow secure ranging. The STS is a sequence of UWB pulses (positive and negative) which are generated by an AES-128 crypto-generator from a 256-bit seed. Only a receiver which knows the seed can produce a valid Channel Impulse Response (CIR) and determine the timestamp of the received UWB frame. The received signal is the convolution of the CIR and transmitted STS. Correlating a received signal with the same STS produces the CIR. If the generated and transmitted STS do not match, then the correlator output is noise. Each peak of the CIR is a radio frequency (RF) path. The timestamp of the RF frame is the time of the 1^{st} Path (FP), i.e., the first peak exceeding a certain threshold value.

In a secure ranging session, all the participating devices have exchanged information to compute the seed for each RF UWB frame involved in the ranging session. Only a receiver which has aligned its local seed with the seed of the transmitted STS pattern can contribute to ranging procedure. Since the seed is secret and not shared with other UWB devices, the timestamps are supposed to be secure and not corruptible by an attack.

However, recent vulnerabilities have been identified in the ranging framework described above. Therefore, improved systems and methods for securing ranging sessions are needed to address security vulnerabilities.

### SUMMARY

In an exemplary aspect, the present disclosure is directed to a method for detecting and cancelling an attack signal during a ranging round. The method also includes receiving a first message from a first device at a second device. The method also includes transmitting a second message from the second device to the first device. The method also includes receiving a third message from the first device at the second device. The method also includes transmitting a fourth message from the second device to the first device. The method also includes computing, at the second device, a first time-of-flight based on a plurality of timestamps associated with the first message, the second message, and the third message. The method also includes receiving a fifth message from the first device at the second device, where the fifth message includes a second time-of-flight computed by the first device or an invalidation message of the ranging round.

In some aspects, implementations may include one or more of the following features. The method may include: determining, at the second device, if an attack occurred on the first message, second message, third message, or fourth message based on a difference between the first time-of-flight and the second time-of-flight; the fifth message further that may include a fourth time-of-flight; the fourth time-of-flight is based on timestamps associated with the first message and second message; the receiving the fifth message is by Bluetooth; the method may include: determining, at the second device, a distance between the first device and the second device based on the first time-of-flight, second time-of-flight, third time-of-flight, and fourth time-of-flight; the transmitting messages is by UWB.

In an exemplary aspect, the present disclosure is directed to a non-transitory machine-readable medium storing instructions that includes receiving a first message from a first device at a second device. The non-transitory machine-readable medium storing instructions also includes transmitting a second message from the second device to the first device. The non-transitory machine-readable medium storing instructions also includes receiving a third message from the first device at the second device. The non-transitory machine-readable medium storing instructions also includes transmitting a fourth message from the second device to the first device. The non-transitory machine-readable medium storing instructions also includes computing, at the second device, a first time-of-flight based on a plurality of timestamps associated with the first message, the second message, and the third message. The non-transitory machine-readable medium storing instructions also includes receiving a fifth message from the first device at the second device, where the fifth message includes a second time-of-flight computed by the first device or an invalidation message of a current ranging round.

In some aspects, implementations may include one or more of the following features. The non-transitory machine-readable medium further storing instructions that, when executed by the one or more processors, cause the one or more processors to perform: determining, at the second device, if an attack occurred on the first message, second message, third message, or fourth message based on a difference between the first time-of-flight and the second time-of-flight. The fifth message further that may include a fourth time-of-flight. The fourth time-of-flight is based on timestamps associated with the first message and second message. The receiving the fifth message is by Bluetooth. The non-transitory machine-readable medium further storing instructions that, when executed by the one or more processors, cause the one or more processors to perform: determining, at the second device, a distance between the first device and the second device based on the first time-of-flight, second time-of-flight, third time-of-flight, and fourth time-of-flight. The transmitting messages is by UWB.

In an exemplary aspect, the present disclosure is directed to a device. The device also includes a transceiver; a non-transitory memory storing instructions; and one or more hardware processors configured to execute the instructions to cause the device to perform operations that may include: receive a first message from a first device at the device; transmit a second message from the device to the first device; receive a third message from the first device at the device; transmit a fourth message from the device to the first device; compute, at the device, a first time-of-flight based on a plurality of timestamps associated with the first message, the second message, and the third message; and receive a fifth message from the first device at the device, where the fifth message includes a second time-of-flight computed by the first device or an invalidation message of a current ranging round.

In some aspects, implementations may include one or more of the following features. The device where the one or more hardware processors are configured to execute the instructions to cause the device to perform operations may include: determine if an attack occurred on the first message, second message, third message, or fourth message based on a difference between the first time-of-flight and the second time-of-flight. The one or more hardware processors are configured to execute the instructions to cause the device to perform operations may include: compute a third time-of-flight based on timestamps associated with the second message and the third message; and where the fifth message further that may include a fourth time-of-flight. The fourth time-of-flight is based on timestamps associated with the first message and second message. The one or more hardware processors are configured to execute the instructions to cause the device to perform operations may include: determine a distance between the first device and the device based on the first time-of-flight, second time-of-flight, third time-of-flight, and fourth time-of-flight. The transmitting messages is by UWB.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description, serve to explain the principles of the disclosure.

FIG. 1 illustrates an attack scenario during UWB device communication.

FIGS. 2A and 2B depict an illustrative authorized and attack signal during a ranging session.

FIG. 3 a simplified diagram of a UWB device, according to some aspects of the present disclosure.

FIG. 4 illustrates a signaling diagram in which a first UWB device communicates with a second UWB device during a ranging round, according to some aspects of the present disclosure.

FIG. 5 illustrates a signaling diagram in which a first UWB device communicates with a second UWB device during a ranging round, according to some aspects of the present disclosure.

FIG. 6 illustrates a signaling diagram in which a first UWB device communicates with a second UWB device during a ranging round, according to some aspects of the present disclosure.

FIG. 7 illustrates a signaling diagram in which a first UWB device communicates with a second UWB device during a ranging round, according to some aspects of the present disclosure.

FIG. 8 illustrates a signaling diagram in which a first UWB device communicates with a second UWB device during a ranging round, according to some aspects of the present disclosure.

FIG. 9 illustrates an exemplary method for attack detection and/or cancellation by a UWB device, according to some aspects of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Additionally, like reference numerals denote like features throughout specification and drawings.

It should be appreciated that the blocks in each signaling diagram or flowchart and combinations of the signaling diagrams or flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each signaling diagram or flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction for performing the functions described in connection with a block(s) in each signaling diagram or flowchart. Since the computer program instructions may be equipped in a computer or other programmable data processing devices, instructions that generate a process executed by a computer as a series of operational steps are performed by the computer or other programmable data processing devices and operate the computer or other programmable data processing devices may provide steps for executing the functions described in connection with a block(s) in each signaling diagram or flowchart.

Each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

Hereinafter, embodiments are described in detail with reference to the accompanying drawings. Further, although a communication system using ultra-wideband (UWB) is described in connection with embodiments, as an example, the embodiments may also apply to other communication systems with similar technical background or features. For example, a communication system using Bluetooth or ZigBee may be included therein. Further, embodiments may be modified in such a range as not to significantly depart from the scope of the present disclosure under the determination by one of ordinary skill in the art and such modifications may be applicable to other communication systems.

UWB may refer to a short-range high-rate wireless communication technology using a wide frequency band of several GHz or more, low spectral density, and short pulse width (e.g., 1 nsec to 4 nsec) in a baseband state. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known, also referred to as anchor devices). The present disclosure assumes that a referenced device is capable of communicating through UWB (referred to as “UWB-enabled user device,” UWB device, user device, or simply device).

References to “ranging round” or “ranging session” should be understood to include other session types, such as, but not limited to, ranging, contention-based-ranging, and data sessions. In this disclosure, the terms “initiator” and “responder” may take their definitions from the FiRa specification but are not limited to the protocols in the FiRa specification. In some instances, the choice of initiator and responder will be negotiated over Bluetooth or other means before a ranging round or session begins. One skilled in the art will appreciate the applicability of the descriptions herein using these, and other, terms to other protocols based on ranging. In some instances, the responder may also be referred to as an access system. Furthermore, the following abbreviations may be used throughout: “CCC” for Car Connectivity Consortium, “BLE” for Bluetooth Low Energy, “DM” for Data Message, “SS-TWR” for Single-Sided Two-Way Ranging, “DS-TWR” for Double-Sided Two-Way Ranging, “RIM” for Ranging Initiation Message, “RRM” for Ranging Response Message, “RRRM” for Ranging Result Report Message, “RFM” for Ranging Final Message, “CRUM T2” for Control Ranging Update Message Type 2, “RCM T3” for Ranging Control Message Type 3, “SIM” for Scheduling Information Message, “FP” for First Path, “CAP” for Contention-Access Period, and “CFP” for Contention-Free Period.

During a ranging session a plurality of UWB-enabled devices attempt to transmit messages, establishing communication between the devices. A session may comprise multiple messages transmitted and received by the UWB-enabled devices. During a ranging session, an attack signal may be transmitted by an unauthorized user/device. The attack signal may cause another device of an access system to believe an authorized user is within a given security bubble (i.e., within a certain distance from the access system, such as a car or house), thereby causing the access system to prematurely allow access. This presents a significant security risk.

Past attempts at addressing these security risks have been application dependent and delayed decision making that is an intended result of a ranging session (e.g., a lock/unlock decision).

Therefore, it is beneficial to have systems and methods capable and detecting and/or canceling an attack signal. For example, by comparing various time of flight measurements and calculations, two or more devices may be able to determine an attack has occurred for one of the messages in the ranging round. In some instances, once an attack has been detected, it may be possible to compensate for the attack. Because an effect of an attack may be to reduce the distance calculation between two devices, one or more devices may be able to calculate the true distance.

Embodiments of the present disclosure provide systems and methods for detecting an attack during a ranging session using two interleaved DS-TWR ranging flows.

Embodiments of the present disclosure provide systems and methods for detecting an attack during a ranging session using a DS-TWR ranging flows, a fourth message, and time-of-flight calculations for two independent SS-TWR ranging flows.

Embodiments of the present disclosure provide systems and methods for exchanging information between two UWB devices to allow detection of an attack, including notification of invalidity based on mismatch of time-of-flight measurements.

Embodiments of the present disclosure provide systems and methods for canceling an attack using the difference in time-of-flight measurements from two DS-TWR flows.

Embodiments of the present disclosure provide systems and methods for canceling an attack using the difference in time-of-flight measurements from two SS-TWR flows.

The disclosed systems and methods can facilitate several improvements. For example, with high probability, the systems and methods detect and cancel many attacks which would otherwise alter a measured distance.

In addition, the disclosed systems and methods improve the security of a transaction between devices without the need for proprietary physical counter-measures which are application dependent. In some instances, the disclosed systems and methods can be combined with proprietary mechanism to facilitate very high security levels. Furthermore, the disclosed systems and methods can detect sophisticated attacks, such as attacks on both the STS pattern and Ipatov preamble. As a result, users may feel more comfortable using UWB technologies to engage in transactions, communication, and with security/access procedures and systems (e.g., unlocking a car door or house, or completing payments automatically after leaving a store, which is identified by a first device such as a person's mobile coming within a certain distance of a store payment system). Additionally, the systems and methods do not require significant additional power, resource, or time costs.

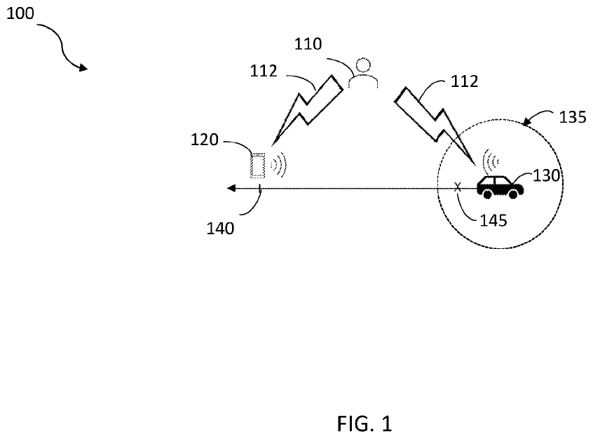

FIG. 1 illustrates an attack scenario during UWB device communication. In attack scenario 100, first UWB device 120 and a second UWB device 130 may be participating in a ranging session. In some embodiments, device 120 and device 130 may also be in communication over Bluetooth. During the ranging session, an attacker 110 may transmit an attack signal 112. Device 120 may be a phone and device 130 may be a relevant subcomponent of a vehicle. In some instances, the effect of the communications between the devices 120 and 130 is to determine when device 120 is within a security zone 135, surrounding device 130. In some instances, the security zone 135 may define a threshold distance beyond which device 130 may not allow access (e.g., a car door will not unlock).

The attack 112 has the effect of convincing device 130 that device 120, instead of being at its true position 140, is within the security zone at a false position 145. Because attack 112 causes the device 130 to determine that device 120 is within the security zone, device 130 may allow access to attacker 110 bypassing security protections.

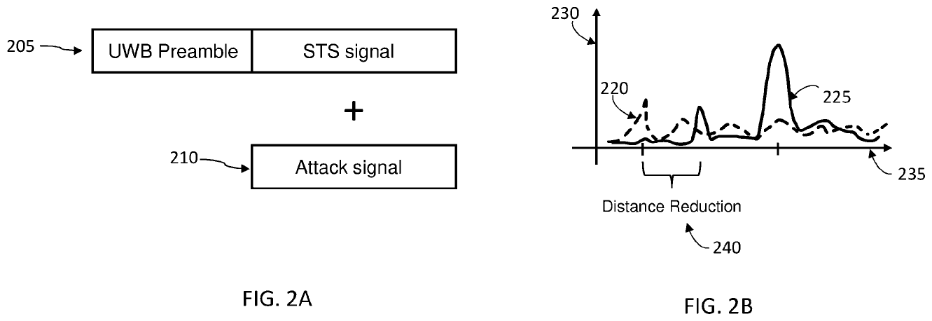

FIGS. 2A and 2B depict an illustrative legitimate signal and attack signal during a ranging session. A portion of a frame of legitimate signal 205 is shown. The attack signal 210, also called a Ghost Peak Attack, is a sequence of strong and random UWB pulses. The STS pattern of the legitimate signal is overlayed with the attack signal. A graph of the overlayed Channel Impulse Responses associated with a legitimate signal 225 and Channel Impulse Response associated with an attack signal 220, is depicted in FIG. 2B with axis 230 representing signal strength and axis 235 representing time. The attack signal is not structured or configured based on knowledge of the seed which generates the STS. Since this attack signal is not generated from the expected seed, it results in noise. If a noise peak is strong enough to exceed the detection threshold, it may be interpreted as RF ray of a multipath channel. And if this peak occurs before the real RF 1^{st} Path (FP), it modifies the timestamp of the UWB ranging frame. In the figure, a noise peak appears ahead of the real FP; it is interpreted as the FP and results in a distance reduction 240.

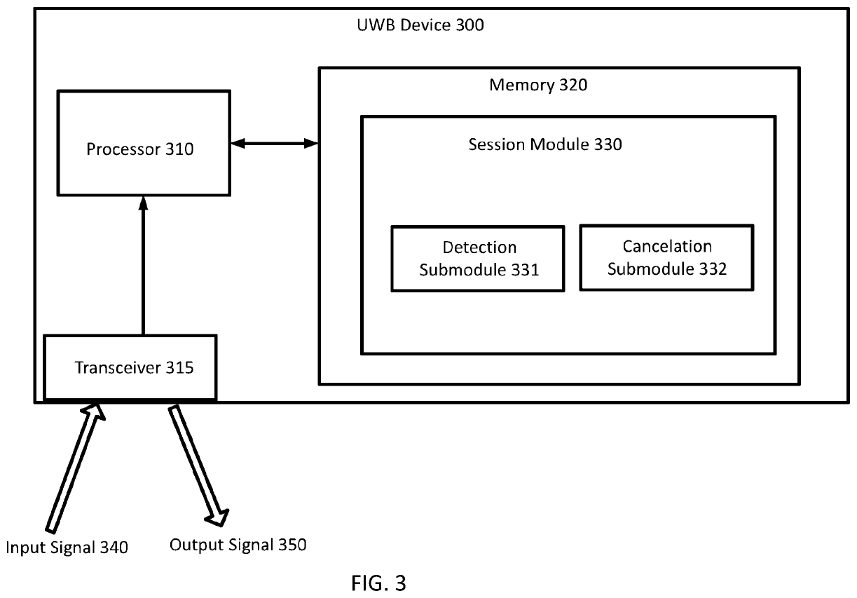

FIG. 3 is a simplified diagram of a UWB device 300. One or more UWB devices 300 may be present in the scenarios and sessions depicted in, and described with respect to, FIGS. 1-2 and 4-8, according to one embodiment described herein. As shown in FIG. 3, UWB device 300 includes a processor 310 coupled to memory 320. Operation of UWB device 300 is controlled by processor 310. And although UWB device 300 is shown with only one processor 310, it is understood that processor 310 may be representative of one or more central processing multi-core processors, microprocessors, microcontrollers, digital signal processors, field programmable gate arrays (FPGAs), application specific integrated circuits (ASICs), graphics processing units (GPUs) and/or the like in UWB device 300. UWB device 300 may be implemented as a stand-alone subsystem, as a board added to a computing device, and/or partially or wholly as a virtual machine.

Memory 320 may be used to store software executed by UWB device 300 and/or one or more data structures used during operation of UWB device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for Session module 330 that may be used to implement and/or emulate the systems and models, and/or to implement any of the methods described herein. Session module 330 may receive input signal 340 via the transceiver 315 and generate an output signal 350 which may be a response to the message contained within the input signal 340. Examples of the input signal may include the messages and transmission from a different UWB device than the one depicted in FIG. 3. The input signal may be structured in frames, which, for example, may take the form as described in the FiRa standard. Examples of the output signal may include transmission by the UWB device 300 in response to a received message and transmission of a message that begins a ranging session.

The transceiver 315 may comprise a transmitter and/or a receiver, an antenna, or any other means of transmitting and/or receiving in UWB. For example, the UWB device 300 may receive the input signal 340 (such as an initial ranging message) from another UWB device at the transceiver 315.

In some embodiments, the Session Module 330 is configured to control the content and timing of output signal 350. The Session Module 330 may further include Detection Submodule 331 (e.g., instructions for calculating time-of-flights, as described herein) and/or Cancelation Submodule 332 (e.g., instructions to modify estimated distances between two UWB devices upon detection of an attack).

Some examples of UWB devices, such as UWB device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

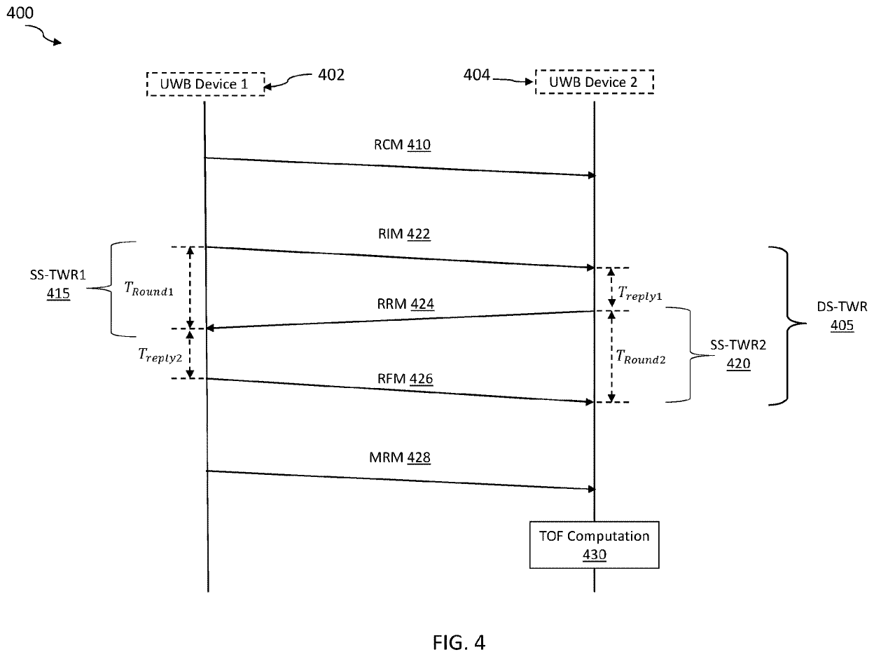

FIG. 4 illustrates a signaling diagram in which a first UWB device 402 communicates with a second UWB device 404 during a session, according to some aspects of the present disclosure. In some embodiments, UWB Device 1 402 is operating as the initiator while UWB Device 2 404 is operating as the responder with respect to a DS-TWR session 405. The session 400 depicts a DS-TWR session 405, which may also be viewed as two SS-TWR sessions 415, 420, where UWB Device 1 402 and UWB Device 2 404 have opposite roles in each of the two SS-TWR sessions. The DS-TWR session 405 is comprised by messages 422, 424, and 426. The first SS-TWR session 415 is comprised by messages 422 and 424, while the second SS-TWR session 420 is comprised by messages 424 and 426. Session 400 may also include a ranging control message (RCM) 410. Time-of-flights (TOFs) may be calculated for each of the TWR sessions, i.e., 405, 415, and 420. The DS-TWR TOF may be calculated as follows:

$${TOF}_{DS - TWR} = \frac{{T}_{Round 1} {T}_{Round 2} - {T}_{reply 1} {T}_{reply 2}}{{T}_{Round 1} + {T}_{Round 2} + {T}_{reply 1} + {T}_{reply 2}} \qquad ( 1 )$$

where T_{Round1} is the time that elapses between UWB Device 1 transmitting RIM 422 and receiving RRM 424, T_{Round2} is the time that elapses between UWB Device 2 transmitting RRM 424 and receiving RFM 426, T_{reply1} is the time that elapses between UWB Device 2 404 receiving RIM 422 and sending RRM 424, and T_{reply2} is the time that elapses between UWB Device 1 402 receiving RRM 424 and transmitting RFM 426. Furthermore, the SS-TWR TOFs may be calculated as follows:

$${TOF}_{SS - TWR 1} = \frac{1}{2} ( {T}_{Round 1} - {T}_{reply 1} ) \qquad ( 2 )$$

$${TOF}_{SS - TWR 2} = \frac{1}{2} ( {T}_{Round 2} - {T}_{reply 2} )$$

In some aspects, TOF_{SS-TWR1} and TOF_{SS-TWR2} are less accurate than TOF_{DS-TWR} because of a clock frequency offset between UWB Device 1 and UWB Device 2. In some instances, UWB Device 2 can compute all three TOFs since it has all the needed timestamps (either locally or received in the MRM 428). Thus, in some instances, UWB Device 2 may make a TOF computation 430 with the available data. These 3 TOFs (one for each TWR 405, 415, and 420) should match if there is no attack of the STS pattern.

During session 400, an attack, such as that described with respect to FIGS. 1-2, may affect one of the messages, such the RIM 422, RRM 424, or RFM 426. If the attacker succeeds in shifting the timestamp of the RIM 422 by dt, TOF_{SS-TWR1} is tampered by dt/2, TOF_{SS-TWR2} is not impacted, and TOF_{DS-TWR} is changed by dt/4. Therefore, the UWB Device 2 can easily detect such an attack by computing and comparing the three TOF values, provided that the tampering magnitude is higher than the accuracy.

In some aspects, with a 1 ms ranging slot, the accuracy is: 1 ms*∈_{CFO}, where ∈_{CFO} is the residual Clock Frequency Offset after compensation. With a CFO compensation better than 1 ppm, the accuracy of the SS-TWR is better than Ins. As an example, assume an attack is detected which tampers the ranging distance by more than 2 m, i.e., a TOF tampering of 3 ns. With these assumptions, the difference between TOF_{SS-TWR1}, TOF_{DS-TWR}, and TOF_{SS-TWR2} is higher than the accuracy. Therefore, the Ghost Peak Attack may be detected. A similar conclusion follows for an attack on RFM 426. However, if an attack signal successfully alters the timestamp of RRM by an amount dt, then all 3 TOFs are altered by dt/2. If there is no difference in the TOFs, then the attack cannot be detected. In that sense, the response message, RRM, is referred to as the weak message in a DS-TWR since an attack can't be detected by the counter-measures described above with respect to FIG. 4. In some aspects, systems and methods provided herein remedy this problem.

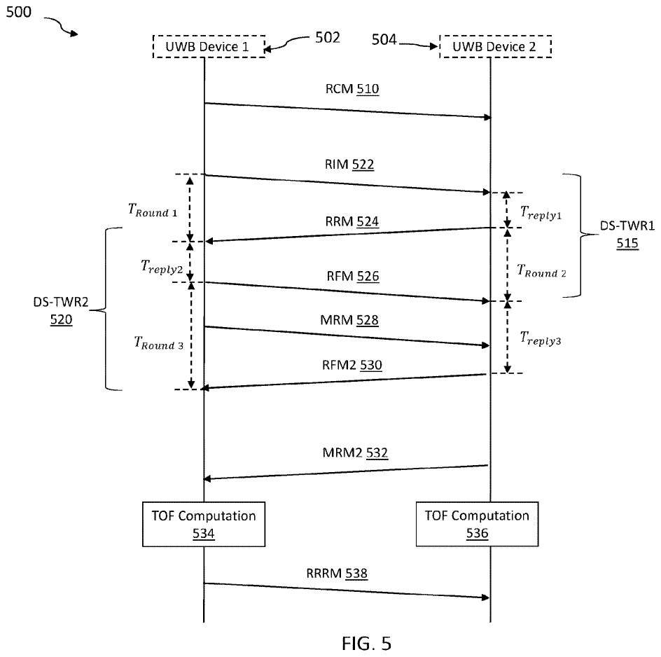

FIG. 5 illustrates a signaling diagram in which a first UWB device communicates with a second UWB device during a session, according to some aspects of the present disclosure. In some aspects, session 500 comprises two interleaved DS-TWR ranging sessions, DS-TWR1 515 and DS-TWR2 520. In some embodiments, for DS-TWR1 515, UWB Device 1 502 may be operating as the initiator while UWB Device 2 504 may be operating as the responder; and, for DS-TWR2 520, UWB Device 1 502 may be operating as the responder while UWB Device 2 504 may be operating as the initiator. DS-TWR1 session 515 includes messages RIM 522, RRM 524, and RFM 526. DS-TWR2 session 520 includes messages RRM 524, RFM 526, and RFM2 530. In some aspects, RFM2 530 acts as a 4th ranging frame. In addition to the messages included in the DS-TWR sessions 515 and 520, session 500 may also include an RCM 510, MRM 528, MRM2 532, and an RRRM 538.

MRM 528 sends the timestamps of the UWB Device 1 to UWB Device 2 so that it can compute its own TOF 536. DS-TWR2 consists of RRM (used as the Initiation Message for this DS-TWR), RFM (used as Response Message) and the 4th ranging message as RFM Type2. UWB Device 2 sends its timestamps to UWB Device 1 via MRM2 532. And the initiator computes the TOF 534 on its side. In some instances, these 2 additional messages are announced by the initiator in the RCM 510.

The UWB Device 2 computes its TOF 536 from DS-TWR1 515. If it detects an attack on the RIM 522 or RFM 526, it notifies the Upper Layer about the attack. The UWB Device 1 computes the TOF 534 from DS-TWR2 520. The TOF for DS-TWR2 may be given by the equation:

$${TOF}_{DS - TWR 2} = \frac{{T}_{Round 3} {T}_{Round 2} - {T}_{reply 3} {T}_{reply 2}}{{T}_{Round 3} + {T}_{Round 2} + {T}_{reply 3} + {T}_{reply 2}} \qquad ( 3 )$$

In DS-TWR2 520, the UWB Device 1 makes the same kind of checks as described with respect to FIG. 4 with two SS-TWR (made by RRM 524 & RFM 526 for the first SS-TWR and RFM 526 & RFM2 530 for the second SS-TWR). In DS-TWR2 520, RRM 524 plays the role of an Initiation message, and the weak message is RFM 526 which plays the role of the Response message. Therefore, the UWB Device 1 can detect any attack on this RRM 524 which is the weak message of the DS-TWR1 515 and will abort any TOF computation if it detects that RRM 524 or RFM2 530 is attacked. Therefore, by combining both interleaved DS-TWRs, an attack can be detected on any ranging message.

The roles of the messages in the two DS-TWR rangings discussed above are organized and displayed in Table 1, below.

TABLE 1

| | DS-TWR1 | | DS-TWR2 | |
|---|---|---|---|---|
| | | Weak (attack is | | Weak (attack is |
| | Role | not detected) | role | not detected) |
| RIM | Initiation | N | Unused | |
| | message | | | |
| RRM | Response | Y | Initial | N |
| | message | | message | |
| RFM | Final | N | Response | Y |
| | message | | message | |
| RFM2 | Unused | | Final | N |
| | | | message | |

At the last stage, the UWB Device 1 may send a Ranging Report Result Message (RRRM 538). In some instances, RRRM 538 contains the TOF 534 computed by UWB Device 1. If UWB Device 1 detects an attack on RRM, it may set the TOF to a value which indicates an attack or it may send the computed TOF value.

The UWB Device 2, in some instances an access system, may make the final decision on whether an attack has occurred by comparing TOFs. Local TOF 536 value and the TOF 534 value sent (e.g., in RRRM 538) by the UWB Device 1 should match pretty well since they are DS-TWR TOFs, which are very accurate TOFs.

For example, assume a Ghost Peak Attack shifts the time-of-arrival of a ranging frame by dt and that the criteria of a Successful Ghost Peak Attack is a shift in the time-of-arrival of dt>2 ns (equivalent to a distance of 60 cm). The DS-TWR TOF is tampered by dt/4 or dt/2 as shown by the table below, i.e., 15 cm or 30 cm. The Ghost Peak Attack is detected if the TOF difference is higher than the typical DS-TWR accuracy. The typical DS-TWR accuracy is better than 0.5 ns (equivalent to 15 cm). The TOF difference is at least dt/4>0.5 ns, which is higher than the DS-TWR accuracy. Therefore, the Ghost Peak Attack is detected.

Alternatively, the UWB Device 1 may not send the RRRM 538; instead, it may use an out-of-band channel to send an alert to the UWB Device 2 if it detects an attack on the RRM 524. In those circumstances, UWB Device 2 will reject the reported ranging distance.

TABLE 2

| | DS-TWR1 | | DS-TWR2 | | |
|---|---|---|---|---|---|
| | | TOF Impact | | TOF impact | |
| | | (Computed | | (computed | |
| | | on UWB | | on UWB | TOF |
| | Role | Device 2) | Role | Device 1) | difference |
| RIM | Initiation | Close | Unused | 0 | +dt/4 |
| | message | to −dt/4 | | | |
| RRM | Response | −dt/2 | Initial | Close | +dt/4 |
| | message | | message | to −dt/4 | |
| RFM | Final | Close | Response | −dt/2 | −dt/4 |
| | message | to −dt/4 | message | | |
| RFM2 | Unused | 0 | Final | Close | −dt/4 |
| | | | message | to −dt/4 | |

Table 2 lists the various impacts to the TOF due to an attack for each of the messages in the two DS-TWR sessions.

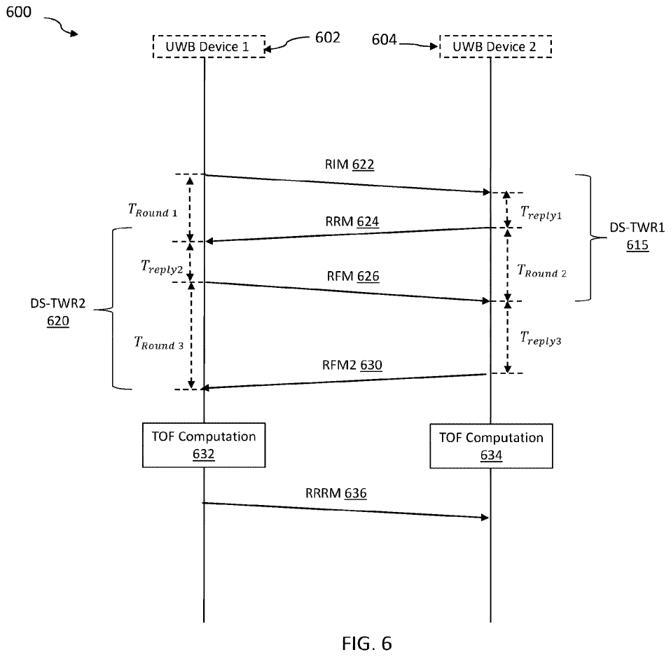

FIG. 6 illustrates a signaling diagram in which a first UWB device communicates with a second UWB device during a ranging round, according to some aspects of the present disclosure. In some aspects, session 600 comprises two interleaved DS-TWR ranging sessions, DS-TWR1 615 and DS-TWR2 620. In some embodiments, for DS-TWR1 615, UWB Device 1 602 may be operating as the initiator while UWB Device 2 604 may be operating as the responder; and, for DS-TWR2 620, UWB Device 1 602 may be operating as the responder while UWB Device 2 604 may be operating as the initiator. DS-TWR1 session 615 includes messages RIM 622, RRM 624, and RFM 626. DS-TWR2 session 620 includes messages RRM 624, RFM 626, and RFM2 630. In some aspects, RFM2 630 acts as a 4th ranging frame. In addition to the messages included in the DS-TWR sessions 615 and 620, session 600 may also include an RRRM 636.

In some embodiments, the interleaved DS-TWR sessions 615 and 620 of session 600 may be done with the non-deferred mode, i.e., with SP1 frames which carry the Measurement Report Messages (i.e., similar to MRM 528 and MRM2 532 as depicted in FIG. 5) in the RFM 626 and RFM2 630 and which carry the Control Message (e.g., similar to RCM 510 in FIG. 5) in the RIM 622. RFM2 630 is indeed a Ranging Final Message frame, except that it is sent by the UWB Device 2. The payload of MRM2 is also similar to the MRM, except that the reference time is different: in current MRM, the time reference is the timestamp of the RIM on the UWB Device 1 side, whereas it is the timestamp of the RRM on the UWB Device 2 side. UWB Device 1 still computes a TOF 632 and UWB Device 2 still computes a TOF 634 with information local to each device or delivered in the messages described above.

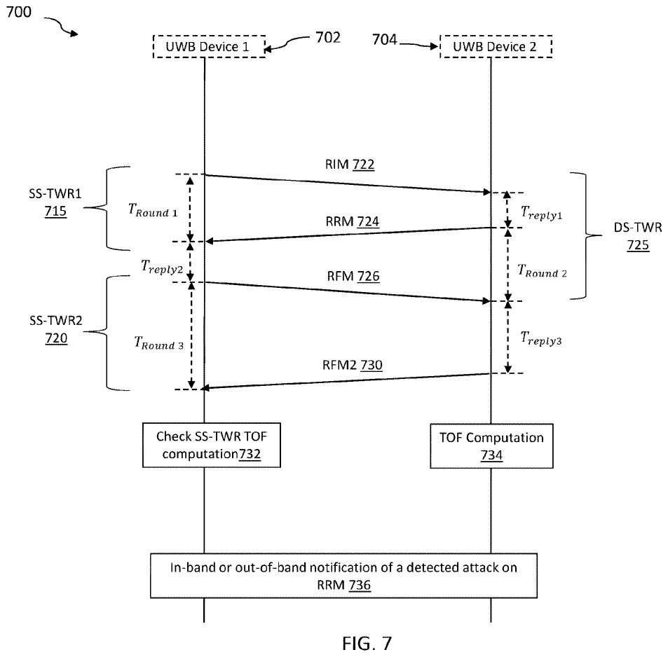

FIG. 7 illustrates a signaling diagram in which a first UWB device communicates with a second UWB device during a ranging round, according to some aspects of the present disclosure. In some aspects, session 700 comprises two SS-TWR ranging sessions, SS-TWR1 715 and SS-TWR2 720, and a DS-TWR ranging session 725. In some embodiments, for both SS-TWR1 715 and SS-TWR2 720, UWB Device 1 702 may be operating as the initiator while UWB Device 2 704 may be operating as the responder. SS-TWR1 session 715 includes messages RIM 722 and RRM 724. SS-TWR2 session 720 includes messages RFM 726 and RFM2 730. In some embodiments, for DS-TWR 725, UWB Device 1 702 may be operating as the initiator while UWB Device 2 04 may be operating as the responder. DS-TWR session 725 includes messages RIM 722, RRM 724, and RFM 726. In some aspects, RFM2 730 acts as a 4th ranging frame. In addition to the messages included in the SS-TWR sessions 715 and 720, session 700 may also include an in-band or out-of-band notification 736.

In a session 700, a 4^{th} ranging message is added (i.e., RFM2 730) but a 2^{nd} DS-TWR is not created. UWB Device 1 702 acts as the initiator of two SS-TWRs. In this flow, the UWB Device 2 704 sends T_{reply1} in RRM 724 whereas in standard DS-TWR flows it is not sent with RRM 724. Then UWB Device 1 702 can compute a 1^{st} SS-TWR TOF 732 according to the equation:

$${TOF}_{SS - TWR 1} = \frac{1}{2} ( {T}_{Round 1} - {T}_{reply 1} ) \qquad ( 4 )$$

UWB Device 2 704 sends a 4^{th} ranging message, RFM2 730, with MRM2 information including T_{reply3}; UWB Device 1 may then compute a 2^{nd} SS-TWR TOF 732 according to the equation:

$${TOF}_{SS - TWR 2} = \frac{1}{2} ( {T}_{Round 3} - {T}_{reply 3} ) \qquad ( 5 )$$

If the TOF of each SS-TWR 715, 720 do not match and the error is more than the expected accuracy, then the UWB Device 1 invalidates the TOF 734 computed for the DS-TWR session 725 on UWB Device 2 side via an in-band or out-of-band message 736. TOF computation 734 for DS-TWR 725 may be done according to Eq. 1.

If the attack succeeds, the position of the Fake First path is random and the probability that the 2 consecutive Fake FPs match within Ins is very low.

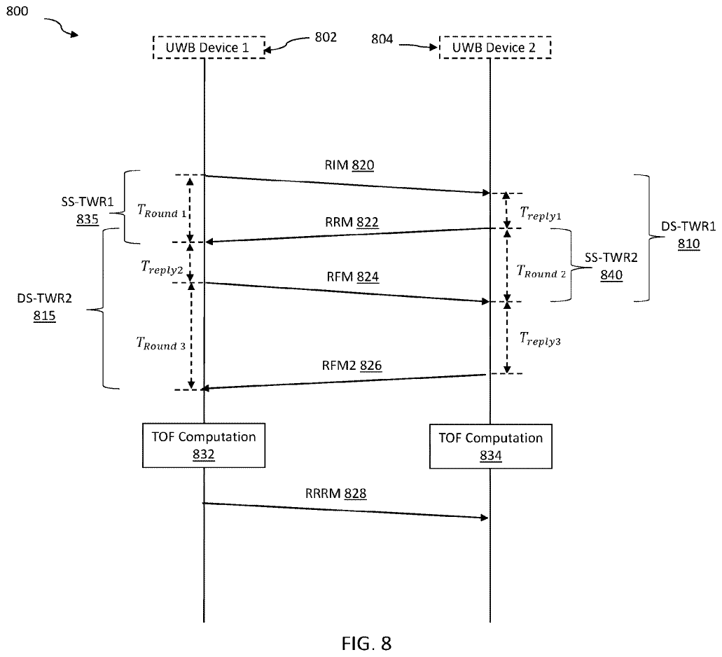

FIG. 8 illustrates a signaling diagram in which a first UWB device communicates with a second UWB device during a ranging round, according to some aspects of the present disclosure. In some aspects, session 800 comprises two interleaved DS-TWR ranging sessions, DS-TWR1 810 and DS-TWR2 815, and two interleaved SS-TWR ranging sessions, SS-TWR1 835 and SS-TWR2 840. In some embodiments, for DS-TWR1 810, UWB Device 1 802 may be operating as the initiator while UWB Device 2 804 may be operating as the responder; for DS-TWR2 815, UWB Device 1 802 may be operating as the responder while UWB Device 2 804 may be operating as the initiator; for SS-TWR1 835, UWB Device 1 802 may be operating as the initiator while UWB Device 2 804 may be operating as the responder; and for SS-TWR2 840, UWB Device 1 802 may be operating as the responder while UWB Device 2 804 may be operating as the initiator. DS-TWR1 session 810 includes messages RIM 820, RRM 822, and RFM 824. DS-TWR2 session 815 includes messages RRM 822, RFM 824, and RFM2 826. SS-TWR1 session 835 includes messages RIM 820 and RRM 822. SS-TWR2 session 840 includes messages RRM 822 and RFM 824. In some aspects, RFM2 826 acts as a 4^{th} ranging frame. In addition to the messages included in the DS-TWR sessions 810, 815 and SS-TWR sessions 835, 840, session 800 may also include an RRRM 828.

In some embodiments, the interleaved DS-TWR sessions 810, 815 and SS-TWR sessions 835, 840 of session 800 may be done with the non-deferred mode, i.e., with SP1 frames which carry the Measurement Report Messages (i.e., similar to MRM 528 and MRM2 532 as depicted in FIG. 5) in the RFM 824 or RFM2 826 or the Control message (e.g., RCM 510 in FIG. 5) in the RIM 820. RFM2 826 is indeed a Ranging Final Message frame, except that it is sent by UWB Device 2. The payload of MRM2 is also similar to the MRM, except that the reference time is different: in current MRM, the time reference is the timestamp of the RIM on the UWB Device 1 side, whereas it is the timestamp of the RRM on the UWB Device 2 side. UWB Device 1 still computes a TOF 832 and UWB Device 2 still computes a TOF 834 with information local to each device or delivered in the messages described above.

Attack cancellation is now discussed with respect to FIG. 8. However, one of ordinary skill in the part will appreciate applicability of the description of attack cancellation to the other ranging sessions as described herein.

Let D_{ds}=TOF (DS-TWR2)−TOF (DS-TWR1). If D_{ds} is higher than the DS-TWR accuracy, then the session 800 is under an attack. As shown in Table 2, if D_{ds}>0, then the attack occurs either on RIM 820 or RRM 822. If the attack occurred on RIM, the TOF 834 measured by UWB Device 2 804 with DS-TWR1 810 shall be compensated by +dt/4=D_{ds}. If the attack occurred on RRM 822, the TOF 834 measured by the UWB Device 2 804 with DS-TWR1 810 shall be compensated by +dt/2.

As shown in Table 2, if D_{ds}<0, then the attack occurs either on RFM 824 or RFM2 826. If the attack occurred on RFM 824, then the TOF 834 measured by UWB Device 2 804 with DS-TWR1 810 shall be compensated by +dt/4. If the attack occurs on RFM2 828, the TOF 834 measured by UWB Device 2 804 with DS-TWR1 810 is not impacted.

If D_{ds}>0, then UWB Device 2 804 must determine whether the RIM 820 or the RRM 822 is under attack, so that it knows what compensation (D_{ds} or 2D_{ds}, respectively) should be applied. For that purpose, the DS-TWR1 810 may be split in to two SS-TWR 835, 840. Let Dₛₛ be the TOF difference between the two SS-TWRs 835, 840. As shown in FIG. 4 and described herein, Dₛₛ=0 if RRM 822 is attacked and it is not zero if RIM 820 is attacked. UWB Device 2 804 can therefore determine whether the RRM 822 is attacked and cancel the attack by correcting the measured distance: True Distance=Measured Distance+|2 D_{ds}|.

Similarly, if D_{ds}<0, the UWB Device 2 804 has to determine whether the RFM 824 or the RFM2 826 is under attack, so that it knows what compensation (|D_{ds}| or none) should be applied. DS-TWR2 may similarly be broken into two SS-TWR sessions and a similar analysis as described above reveals which of the two messages, RFM 824 or RFM2 826, was attacked. The difference in the TOF measurements for these two SS-TWR sessions, Dₛₛ, is not 0 if RFM 824 is attacked and Dₛₛ=0 if RFM2 826 is attacked.

Using this information, which ranging frame is attacked and correction necessary to cancel the attack can be determined:

TABLE 3

| TOF Difference | |
|---|---|
| (Message Attacked) | Distance Correction |
| D_{ds} > 0 & | True Distance = Measured |
| Dₛₛ = 0 (RRM) | Distance + 2* D_{ds} |
| D_{ds} > 0 & | True Distance = Measured |
| Dₛₛ is not 0 (RIM) | Distance + D_{ds} |
| D_{ds} < 0 & | True Distance = Measured |
| Dₛₛ is not 0 (RFM) | Distance − D_{ds} |
| D_{ds} < 0 & | True Distance = Measured Distance |
| Dₛₛ = 0 (RFM2) | |

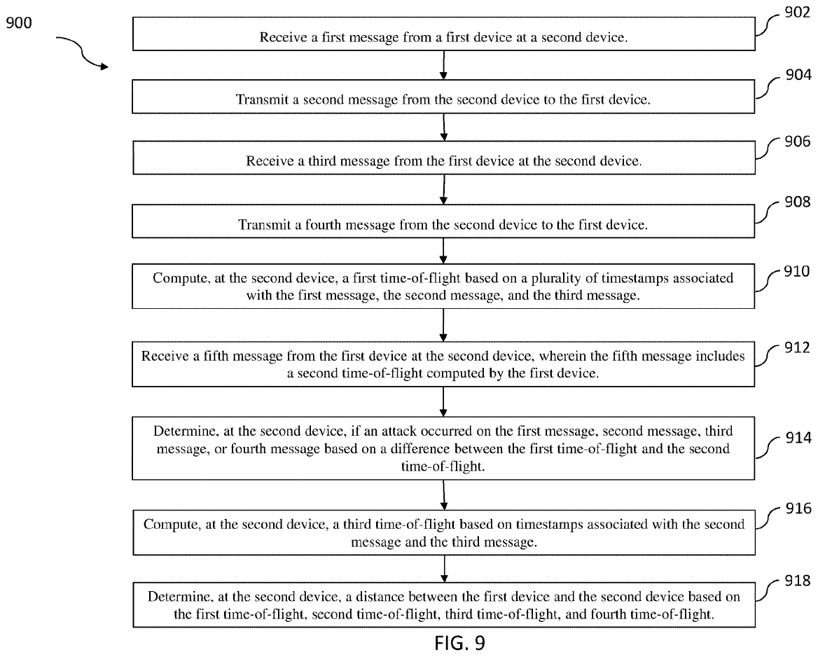

FIG. 9 illustrates an exemplary method for attack detection and/or cancellation by a UWB device, according to some aspects of the present disclosure. Method 900 is merely an example, and is not intended to limit the present disclosure beyond what is explicitly recited in the claims. Additional operations can be provided before, during, and after the method 900, and some operations described can be replaced, eliminated, or moved around for additional embodiments of FIGS. 3-8. For ease of illustration, FIG. 9 is described in connection with FIGS. 1-8. In some embodiments, method 900 may be implemented by a device such as UWB Device 300, as in FIG. 3, or any of the UWB Devices described herein.

At step 902, a second device (e.g., UWB Device 2 804 in FIG. 8) receives a first message (e.g., RIM 820 in FIG. 8) from a first device (e.g., UWB Device 1 802 in FIG. 8). In some embodiments, data is transmitted and received over UWB.

At step 904, a second device transmits a second message (e.g., RRM 822 in FIG. 8) to the first device. In some embodiments, data is transmitted and received over UWB.

At step 906, a second device receives a third message (e.g., RFM 824 in FIG. 8) from the first device. In some embodiments, data is transmitted and received over UWB.

At step 908, a second device transmits a fourth message (e.g., RFM2 826 in FIG. 8) to the first device. In some embodiments, data is transmitted and received over UWB.

At step 910, a second device computes a first time-of-flight (e.g., TOF for DS-TWR1 810 as described herein) based on a plurality of timestamps associated with the first message, the second message, and the third message (e.g., messages comprising DS-TWR1 810 in FIG. 8).

At step 912, a second device receives a fifth message (e.g., RRRM 828 in FIG. 8) from the first device, wherein the fifth message includes a second time-of-flight (e.g., TOF fir DS-TWR2 815 as described herein) computed by the first device.

In some embodiments the second time-of-flight may be received over Bluetooth or other out-of-band modes. In some embodiments, data is transmitted and received over UWB.

At step 914, a second device determines if an attack (e.g., as depicted, and described with respect to, FIGS. 1-2 and listed in Table 3) occurred on the first message, second message, third message, or fourth message based on a difference between the first time-of-flight and the second time-of-flight.

At step 916, a second device computes a third time-of-flight (e.g., TOF for SS-TWR2 840 as described herein) based on timestamps associated with the second message and the third message. In some embodiments the fifth message may include a fourth time of flight (e.g., TOF for SS-TWR1 835 as described herein).

At step 918, a second device determines a distance (e.g., the “True Distance” listed in Table 3 and described herein) between the first device and the second device based on the first time-of-flight, second time-of-flight, third time-of-flight, and fourth time-of-flight. In some embodiments, a second device may compare the distance between the first device and second device with a threshold distance (e.g., the security zone as described in and with respect to FIG. 1). In some embodiments, the second device may deny access to the first device if the distance between the first device and second device is greater than the threshold distance. In some embodiments, the second device may grant access to the first device if the distance between the first device and second device is less than the threshold distance. For example, the distance between the first device and second device may be an accurate estimate of the distance between first UWB device 120 and second UWB device 130 in FIG. 1. The security zone 135 corresponds to the threshold distance.

While some of the terms used herein may match or approximate those of a particular standard, such as FiRa, those skilled in the art will recognize their relevance and application to other protocols based on the concept of ranging round (e.g., as defined in the CCC-Car Connectivity Consortium).

Those skilled in the art will recognize improvements and modifications to the preferred embodiments of the present disclosure. All such improvements and modifications are considered within the scope of the concepts disclosed herein and the claims that follow

What is claimed is:

1. A method for detecting and cancelling an attack signal during a ranging round comprising:
receiving a first message from a first device at a second device;
transmitting a second message from the second device to the first device;
receiving a third message from the first device at the second device;
transmitting a fourth message from the second device to the first device;
computing, at the second device, a first time-of-flight based on a plurality of timestamps associated with the first message, the second message, and the third message; and
receiving a fifth message from the first device at the second device, wherein the fifth message includes a second time-of-flight computed by the first device or an invalidation message of the ranging round.

2. The method of claim 1, further comprising:
determining, at the second device, if an attack occurred on the first message, second message, third message, or fourth message based on a difference between the first time-of-flight and the second time-of-flight.

3. The method of claim 2, further comprising:
computing, at the second device, a third time-of-flight based on timestamps associated with the second message and the third message; and
wherein the fifth message further comprises a fourth time-of-flight.

4. The method of claim 3, wherein the fourth time-of-flight is based on timestamps associated with the first message and second message.

5. The method of claim 3, further comprising:
determining, at the second device, a distance between the first device and the second device based on the first time-of-flight, second time-of-flight, third time-of-flight, and fourth time-of-flight; and
comparing, at the second device, the distance between the first device and second device with a threshold distance,
wherein, if the distance between the first device and second device is greater than the threshold distance, then second device denies access to the first device, and if the distance between the first device and second device is less than the threshold distance, then the second device grants access to the first device.

6. The method of claim 5, wherein the transmitting messages is by UWB.

7. The method of claim 4, wherein the receiving the fifth message is by Bluetooth.

8. A non-transitory machine-readable medium storing instructions that, when executed by one or more processors, cause the one or more processors to perform:
receiving a first message from a first device at a second device;
transmitting a second message from the second device to the first device;
receiving a third message from the first device at the second device;
transmitting a fourth message from the second device to the first device;
computing, at the second device, a first time-of-flight based on a plurality of timestamps associated with the first message, the second message, and the third message; and
receiving a fifth message from the first device at the second device, wherein the fifth message includes a second time-of-flight computed by the first device or an invalidation message of a current ranging round.

9. The non-transitory machine-readable medium of claim 8, further storing instructions that, when executed by the one or more processors, cause the one or more processors to perform:
determining, at the second device, if an attack occurred on the first message, second message, third message, or fourth message based on a difference between the first time-of-flight and the second time-of-flight.

10. The non-transitory machine-readable medium of claim 9, further storing instructions that, when executed by the one or more processors, cause the one or more processors to perform:
computing, at the second device, a third time-of-flight based on timestamps associated with the second message and the third message; and
wherein the fifth message further comprises a fourth time-of-flight.

11. The non-transitory machine-readable medium of claim 10, wherein the fourth time-of-flight is based on timestamps associated with the first message and second message.

12. The non-transitory machine-readable medium of claim 10, further storing instructions that, when executed by the one or more processors, cause the one or more processors to perform:
determining, at the second device, a distance between the first device and the second device based on the first time-of-flight, second time-of-flight, third time-of-flight, and fourth time-of-flight;
comparing, at the second device, the distance between the first device and second device with a threshold distance,
wherein, if the distance between the first device and second device is greater than the threshold distance, then second device denies access to the first device, and if the distance between the first device and second device is less than the threshold distance, then the second device grants access to the first device.

13. The non-transitory machine-readable medium of claim 12, wherein the transmitting messages is by UWB.

14. The non-transitory machine-readable medium of claim 11, wherein the receiving the fifth message is by Bluetooth.

15. A device, comprising:
a transceiver;
a non-transitory memory storing instructions; and
one or more hardware processors configured to execute the instructions to cause the device to perform operations comprising:
receive a first message from a first device at the device;
transmit a second message from the device to the first device;
receive a third message from the first device at the device;
transmit a fourth message from the device to the first device;
compute, at the device, a first time-of-flight based on a plurality of timestamps associated with the first message, the second message, and the third message; and
receive a fifth message from the first device at the device, wherein the fifth message includes a second time-of-flight computed by the first device or an invalidation message of a current ranging round.

16. The device of claim 15, wherein the one or more hardware processors are configured to execute the instructions to cause the device to perform operations further comprising:
determine if an attack occurred on the first message, second message, third message, or fourth message based on a difference between the first time-of-flight and the second time-of-flight.

17. The device of claim 16, wherein the one or more hardware processors are configured to execute the instructions to cause the device to perform operations further comprising:
compute a third time-of-flight based on timestamps associated with the second message and the third message; and
wherein the fifth message further comprises a fourth time-of-flight.

18. The device of claim 17, wherein the fourth time-of-flight is based on timestamps associated with the first message and second message.

19. The device of claim 17, wherein the one or more hardware processors are configured to execute the instructions to cause the device to perform operations further comprising:
determine a distance between the first device and the device based on the first time-of-flight, second time-of-flight, third time-of-flight, and fourth time-of-flight;
compare, at the second device, the distance between the first device and second device with a threshold distance,
wherein, if the distance between the first device and second device is greater than the threshold distance, then second device denies access to the first device, and if the distance between the first device and second device is less than the threshold distance, then the second device grants access to the first device.

20. The device of claim 19, wherein the transmitting messages is by UWB.
